(19) United States
(12) Patent Application Publication
(10) Pub. No.: US 2012/0176116 A1
(43) Pub. Date: Jul. 12, 2012

(54) OUTPUT CIRCUIT

(75) Inventor: Masahiro KITAGAWA, Nukata-gun (JP)

(73) Assignee: DENSO CORPORATION, Kariya-city (JP)

(21) Appl. No.: 13/332,731

(22) Filed: Dec. 21, 2011

(30) Foreign Application Priority Data
Jan. 7, 2011 (JP) 2011-1963

(51) Int. Cl. G05F 3/02

(52) U.S. Cl. 323/312

(57) ABSTRACT

An output circuit includes a driving transistor, an output transistor, a current limiting element, and a switching transistor. A first terminal of each of the driving transistor and the output transistor is connected to a power line. The current limiting element is connected between a second terminal of the driving transistor and a control terminal of the output transistor. The switching transistor is connected in parallel with the current limiting element. The output transistor and the switching transistor have the same junction type or the same conductivity type. A control terminal of the switching transistor is connected to the control terminal of the output transistor.

### CROSS REFERENCE TO RELATED APPLICATION

This application is based on and claims priority to Japanese Patent Application No. 2011-1963 filed on Jan. 7, 2011, the contents of which are incorporated by reference.

### FIELD

The present invention relates to an output circuit including a driving transistor and an output transistor connected to a power line.

### BACKGROUND

An output circuit is a circuit for energizing and de-energizing a load by driving an output transistor using a driving transistor. Rapid energization and de-energization of the load can cause a large noise that affects an on-board vehicle device such as a radio. Such a noise may be reduced by reducing a rate of change of a load current at the time of energization and de-energization by reducing a rate of change of a control voltage of the output transistor. However, the reduction in the rate of change of the control voltage results in an increase in a turn-on time and a turn-off time.

An output circuit disclosed in JP-A-11-145806 includes a small current driving circuit and a large current driving circuit. In the output circuit, an output transistor is driven by both the small current driving circuit and the large current driving circuit until a control voltage of the output transistor reaches a threshold voltage at the time of turn-on. Then, after the control voltage of the output transistor reaches the threshold voltage, the output transistor is driven by only the small current driving circuit.

An output circuit disclosed in JP-A-7-226663 includes a resistor connected in series with a driving transistor. The resistor is bypassed until a control voltage of an output transistor reaches a threshold voltage to increase a driving current. Then, after the control voltage of the output transistor reaches the threshold voltage, the driving current is reduced by the resistor.

The output circuit disclosed in JP-A-11-145806 requires two driving circuits and therefore is increased in size and cost.

In the output circuit disclosed in JP-A-7-226663, if the threshold voltage of the output transistor varies, an actual bypass period where the resistor is actually bypassed may deviate from a designed bypass period where the resistor is designed to be bypassed. As a result, a turn-on time may be increased, or noise may occur.

### SUMMARY

In view of the above, it is an object of the present invention to provide an output circuit for reducing a turn-off time and for reducing noise at the time of turn-off regardless of a variation in a threshold voltage of an output transistor.

According to an aspect of the present invention, an output circuit includes a driving transistor, an output transistor, a current limiting element, and a switching transistor. The driving transistor has a first terminal, a second terminal, and a control terminal. The first terminal of the driving transistor is connected to a power line. The output transistor has a first terminal and a control terminal. The first terminal of the output transistor is connected to the power line. The current limiting element is connected between the second terminal of the driving transistor and the control terminal of the output transistor. The switching transistor is connected in parallel to the current limiting element. The output transistor and the switching transistor have the same junction type or the same conductivity type. The control terminal of the switching transistor is connected to the control terminal of the output transistor.

### BRIEF DESCRIPTION OF THE DRAWINGS

The above and other objects, features, and effects will become more apparent from the following description and drawings in which like reference numerals depict like elements. In the drawings:

FIG. 1 is a diagram illustrating an output circuit according to a first embodiment of the present invention;

FIGS. 2A-2C are diagrams illustrating a timing chart of the output circuit of FIG. 1, and FIGS. 2D-2E are diagrams illustrating a timing chart of the output circuit of FIG. 1 from which a switching transistor is removed;

FIG. 3 is a diagram illustrating an output circuit according to a second embodiment of the present invention;

FIG. 4 is a diagram illustrating an output circuit according to a third embodiment of the present invention;

FIG. 5 is a diagram illustrating an output circuit according to a fourth embodiment of the present invention;

FIG. 6 is a diagram illustrating an output circuit according to a fifth embodiment of the present invention;

FIG. 7 is a diagram illustrating an output circuit according to a sixth embodiment of the present invention;

FIG. 8 is a diagram illustrating an output circuit according to a seventh embodiment of the present invention;

FIG. 9 is a diagram illustrating an output circuit according to an eighth embodiment of the present invention;

FIG. 10 is a diagram illustrating an output circuit according to a ninth embodiment of the present invention; and

FIG. 11 is a diagram illustrating an output circuit according to a tenth embodiment of the present invention.

### DETAILED DESCRIPTION OF THE PREFERRED EMBODIMENTS

Throughout embodiments described below, VGS(Tn), VDS(Tn), and Vth(Tn) represent a gate-source voltage, a drain-source voltage, and a threshold voltage of a transistor Tn, respectively, where n is a positive integer.

### First Embodiment

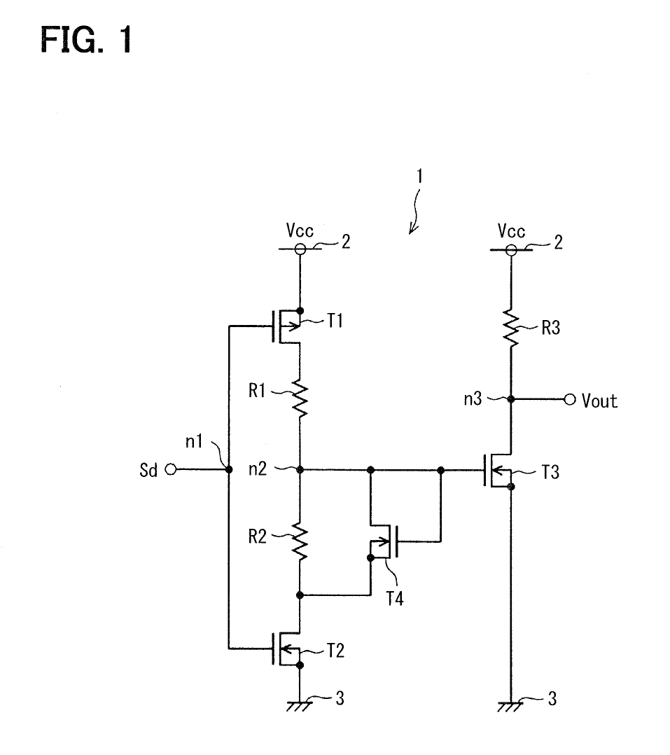

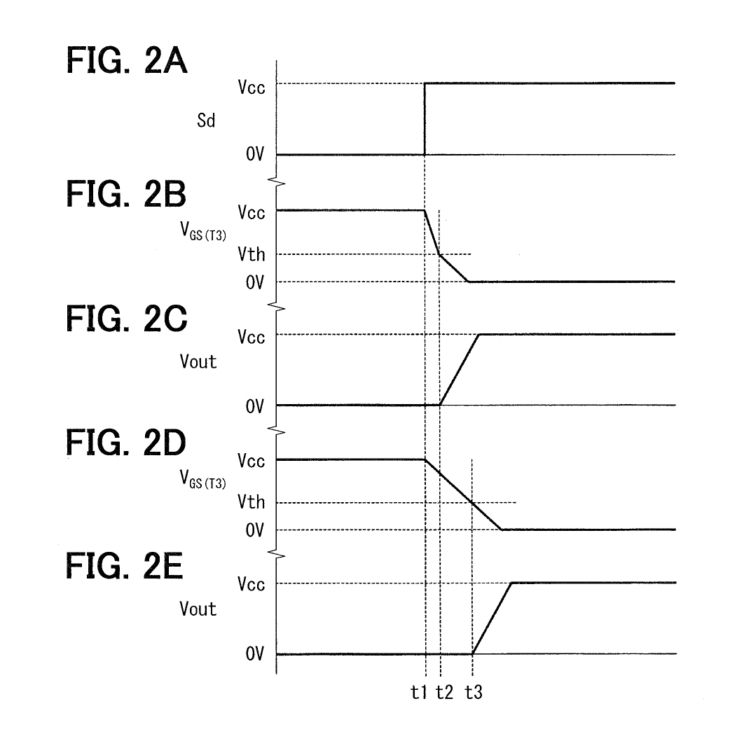

An output circuit 1 according to a first embodiment of the present invention is described below with reference to FIGS. 1 and 2. The output circuit 1 and other circuits (not shown) are implemented together as an integrated circuit (IC) in a complementary metal-oxide semiconductor (CMOS) process. In the output circuit 1, a P-channel driving transistor T1, a resistor R1, a resistor R2, and an N-channel driving transistor T2 are connected in series between a first power line 2 and a second power line 3. The first power line 2 is supplied with a power supply voltage Vcc, and the second power line 3 is grounded. The gates of the transistors T1, T2 are connected together to from an input node n1 for receiving a driving signal Sd. A resistor R3 and an N-channel output transistor T3 are connected in series between the first power line 2 and the second power line 3. A node between the resistor R3 and the output transistor T3 forms an output node n3 for outputting an output voltage Vout. Although not in the drawings, a load is connected between the first power line 2 and the output node n3 and thus low-side driven.

The sources of the transistors T2, T3 are connected to the second power line 3 and thus grounded. The resistors R1, R2 are connected in series between the drains (non-grounded terminal) of the transistors T1, T2. A node n2 between the resistors R1, R2 is connected to the gate of the transistor T3. An N-channel switching transistor T4, which has the same conductivity type as the transistor T3, is connected in parallel with the resistor R2. The gate of the transistor T4 is connected to the gate of the transistor T3.

The resistors R1, R2 serve as a current limiting element for causing the output voltage Vout to change gently. The resistors R1, R2 limits a current that charges and discharges a gate capacitance of the transistor T3 when the transistor T3 is turned ON and OFF. Thus, the output voltage Vout and an output current flowing through the load change gently so that noise (in particular, noise on a radio mounted on a vehicle) at the time of energization and de-energization of the load can be reduced.

According to the first embodiment, threshold voltages Vth(T3), Vth(T4) of the transistors T3, T4 are designed to be equal to each other. The transistors T3, T4 are laid out adjacent to each other and manufactured in the same process. Therefore, even when the threshold voltages Vth(T3), Vth(T4) vary from design values due to manufacturing errors, the variations in the threshold voltages Vth(T3), Vth(T4) become almost equal to each other so that the threshold voltages Vth(T3), Vth(T4) can become almost equal to each other.

FIGS. 2A-2C are diagrams illustrating a timing chart of the output circuit 1 when the drive signal Sd changes from a low level (0V) to a high level (Vcc). FIG. 2A shows the drive signal Sd. FIG. 2B shows the gate-source voltage VGS(T3) of the transistor T3. FIG. 2C shows the output voltage Vout at the node n3. FIGS. 2D and 2E are diagrams illustrating a timing chart of the output circuit of FIG. 1 from which the switching transistor T4 is removed. FIG. 2D shows the gate-source voltage VGS(T3) of the transistor T3. FIG. 2E shows the output voltage Vout at the node n3.

When the drive signal Sd is at the low level, the transistor T1 is ON, and the transistor T2 is OFF. Therefore, the gate-source voltage VGS(T3) is almost equal to the power supply voltage Vcc so that the transistor T3 can be ON. At this time, the output voltage Vout is almost 0V, and a load current flows through the transistor T3.

Then, when the drive signal Sd changes from the low level to the high level at a time t1, the transistor T1 is turned OFF, and the transistor T2 is turned ON. As a result, the drain-source voltage VDS(T2) of the transistor T2 decreases to almost 0V. At this time, the following formula (1) is satisfied.

VGS(T4)+VDS(T2)=VGS(T3) (1)

The transistor T4 is turned ON when the following formula (2) is satisfied.

VGS(T4)=VGS(T3)-VDS(T2)≧Vth(T4) (2)

The transistor T4 is turned ON immediately after the time t1 upon satisfaction of the formula (2). When the transistor T4 is turned ON, the charge stored in the gate capacitance of the transistor T3 are discharged rapidly through the transistors T4, T2 by bypassing the resistor R2. As a result, the gate-source voltage VGS(T3) of the transistor T3 sharply decreases. Then, when the gate-source voltage VGS(T3) decreases below Vth(T4)+VDS(T2) at a time t2, the transistor T4 is turned OFF. After the transistor T4 is turned OFF, the charge stored in the gate capacitance of the transistor T3 is discharged gently through the resistor R2 and the transistor T2. As a result, the gate-source voltage VGS(T3) of the transistor T3 decreases gently.

As mentioned previously, according to the first embodiment, the threshold voltages Vth(T3), Vth(T4) of the transistors T3, T4 are equal to each other. Therefore, when the gate-source voltage VGS(T3) decreases, the transistor T4 is turned OFF before the transistor T3 is turned OFF. Then, when the gate-source voltage VGS(T3) decreases by the amount of the drain-source voltage VDS(T2), the transistor T3 starts to be turned OFF. It is noted that the drain-source voltage VDS(T2) is very small. Therefore, the transistors T3, T4 are turned OFF almost at the same time. A current flowing through the transistor T3 and the output voltage Vout remain unchanged until the time t2. Then, when the gate-source voltage VGS(T3) decreases to the threshold voltage Vth(T3) at the time t2, the current flowing through the transistor T3 decreases gently, and the output voltage Vout increases gently.

In contrast, as shown in FIGS. 2D and 2E, when the output circuit 1 does not have the switching transistor T4, the charge stored in the gate capacitance of the transistor T3 is always discharged through the resistor R2 and the transistor T2.

As described above, according to the first embodiment, the transistor T4 is kept ON to bypass the resistor R2 until the gate-source voltage VGS(T3) of the transistor T3 decreases to the threshold voltage Vth(T3) of the transistor T3. In such an approach, the VGS(T3) decreases in a short time so that a turn-off time can be reduced. Then, when the VGS(T3) decreases below the threshold voltage Vth(T3), the transistor T4 is turned OFF so that the resistor R2 can be connected to a discharge path through which the charge in the gate capacitance of the transistor T3 is discharged. Thus, the VGS(T3) decreases gently after the transistor T4 is turned OFF. Therefore, the current change rate at the time of de-energization is reduced so that noise at the time of de-energization can be reduced. These effects of the first embodiment are produced by adding only the transistor T4. Therefore, an increase in size of the output circuit 1 can be avoided.

Further, according to the first embodiment, the threshold voltages Vth(T3), Vth(T4) of the transistors T3, T4 are designed so that Vth(T3)=Vth(T4) (Vth(T3) =Vth(T4)+VDS(T2), to be exact), and the transistors T3, T4 are laid out adjacent to each other and manufactured in the same process. In such an approach, even when the threshold voltages Vth(T3), Vth(T4) vary from the design values due to manufacturing errors, the variations in the threshold voltages Vth(T3), Vth(T4) become almost equal to each other so that the threshold voltages Vth(T3), Vth(T4) can become almost equal to each other. For example, if the Vth(T4) is larger than the Vth(T3), the transistor T4 is turned OFF early so that a turn-off time can be increased. For another example, if the Vth(T4) is smaller than the Vth(T3), a sharp current change occurs so that noise can be increased. Such diseffects can be overcome by the first embodiment, because the threshold voltages Vth(T3), Vth(T4) become almost equal to each other. Even when Vth(T3)≠Vth(T4), noise at the time of de-energization can be reduced on condition that Vth(T3)≦Vth(T4) (Vth(T3)≦Vth(T4)+VDS(T2), to be exact).

### Second Embodiment

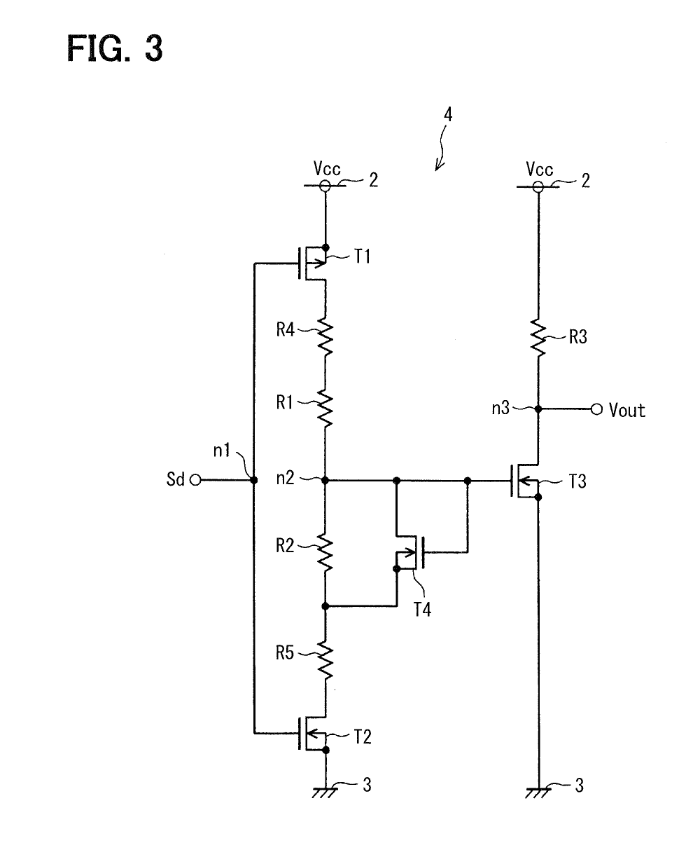

An output circuit 4 according to a second embodiment of the present invention is described below with reference to FIG. 3. The second embodiment differs from the first embodiment in the following points.

The output circuit 4 further includes resistors R4 and R5. The resistor R4 is connected between the transistor T1 and the resistor R1. The resistor R5 is connected between the transistor T2 and the parallel circuit of the resistor R2 and the transistor T4. The resistor R5 serves as a regulatory element for generating a voltage corresponding to a current flowing therethrough. In the output circuit 4, the following formula (3) is satisfied.

VGS(T4)+V(R5)+VDS(T2)=VGS(T3) (3)

In the formula (3), V(R5) represents a voltage generated across the resistor R5 when the transistor T4 is ON.

In the output circuit 1 according to the first embodiment, Vth(T3)=Vth(T4). Therefore, when the VGS(T3) starts to decrease, the transistor T4 is turned OFF before the transistor T3 is turned OFF. Thus, the VGS(T3) can decrease gently. However, for example, due to the fact that the size of the transistor T3 is larger than the size of the transistor T4, there is a possibility that Vth(T4)+VDS(T2) <Vth(T3). In this case, the transistor T4 remains ON, even after the VGS(T3) decreases below the Vth(T3). As a result, noise may be increased due to a sharp current change.

In contrast, in the output circuit 4 according to the second embodiment, the following formula (4) or formula (5) can be satisfied by adjusting a resistance of the resistor R5.

Vth(T4)+V(R5)+VDS(T2) Vth(T3) (4)

Vth(T4)+V(R5) Vth(T3) (5)

When the VGS(T3) decreases under a condition that at least one of the formula (4) and the formula (5) is satisfied, the transistor T4 is turned OFF before the transistor T3 is turned OFF Thus, the sharp current change is prevented so that the noise increase can be prevented.

If Vth(T4)>Vth(T3), the charge in the gate capacitance of the transistor T3 is discharged through the resistor R5 during a period of time when the transistor T4 is ON. Then, when the transistor T4 is turned OFF, the charge in the gate capacitance of the transistor T3 is discharged through the series circuit of the resistor R2 and the resistor R5. Thus, the gate-source voltage VGS(T3) is reduced by a gradual limited current. Therefore, the sharp current change is prevented so that the noise increase can be prevented.

### Third Embodiment

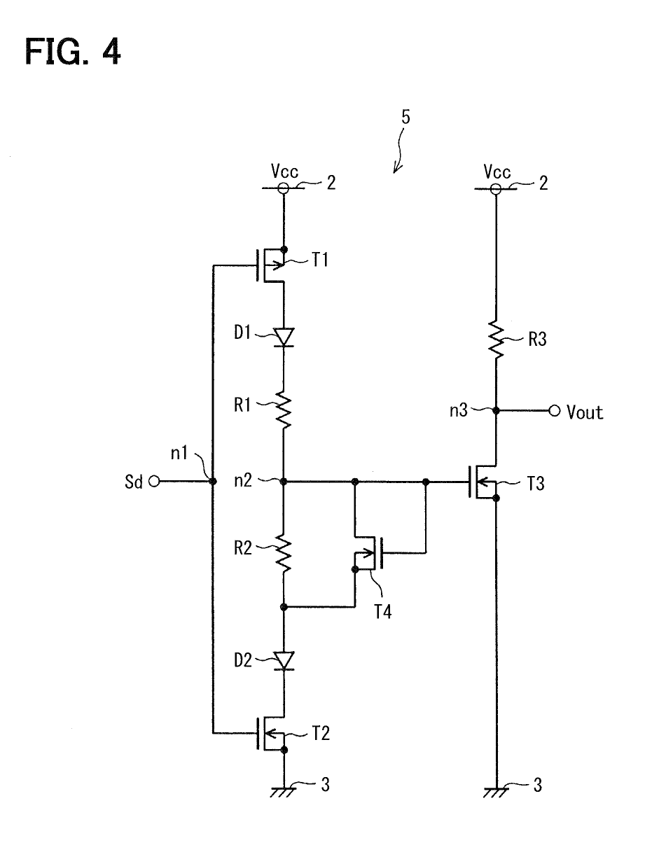

An output circuit 5 according to a third embodiment of the present invention is described below with reference to FIG. 4. The third embodiment differs from the second embodiment in the following points.

The output circuit 5 includes diodes D1 and D2 instead of the resistors R4 and R5, respectively. The diode D1 is connected between the transistor T1 and the resistor R1. The diode D2 is connected between the transistor T2 and the parallel circuit of the resistor R2 and the transistor T4. The diode D2 serves as a regulatory element for generating a voltage corresponding to a current flowing therethrough. In the output circuit 5, the following formula (6) is satisfied.

VGS(T4)+Vf+VDS(T2) =VGS(T3) (6)

In the formula (6), Vf represents a forward voltage of the diode D2.

In the output circuit 5 according to the third embodiment, when Vth(T4)+VDS(T2) <Vth(T3), the following formula (7) or formula (8) can be satisfied. Therefore, the sharp current change is prevented so that the noise increase can be prevented.

Vth(T4)+Vf+VDS(T2) Vth(T3) (7)

Vth(T4)+Vf≧Vth(T3) (8)

Further, in the output circuit 5, when the drive signal Sd is at the low level, the VGS(T3) does not increase above (Vcc-VDS(T1)-Vf). The charge in the gate capacitance of the transistor T3 is reduced accordingly so that a turn-off time when the drive signal Sd changes from the low level to the high level can be reduced. Further, when the drive signal Sd is at the high level, the VGS(T3) does not decrease below (Vf+VDS(T2)). Accordingly, a turn-off time when the drive signal Sd changes from the high level to the low level can be reduced.

### Fourth Embodiment

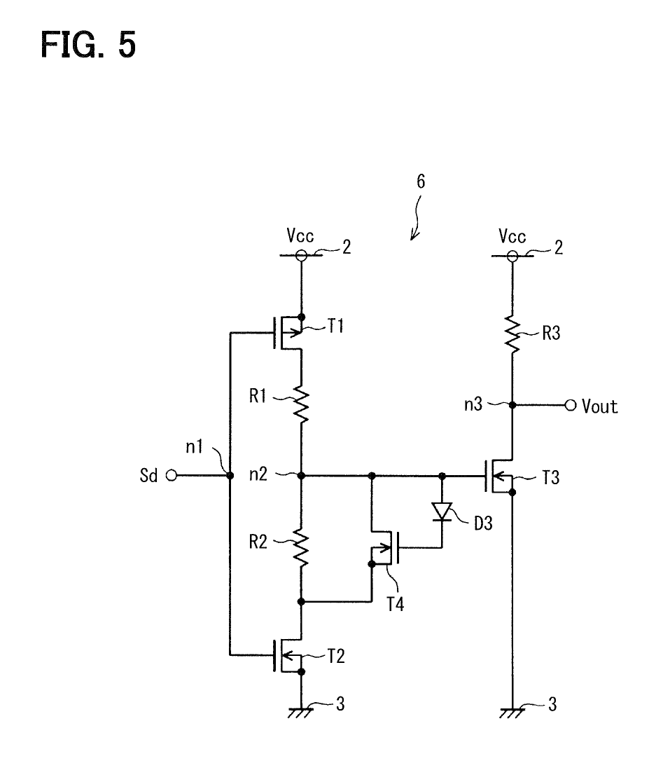

An output circuit 6 according to a fourth embodiment of the present invention is described below with reference to FIG. 5. The fourth embodiment differs from the first embodiment in the following points.

The output circuit 6 further includes a diode D3 connected between the gate of the transistor T4 and the gate of the transistor T3. The diode D3 serves as a regulatory element for generating a voltage corresponding to a current flowing therethrough. In the output circuit 6, the formula (6), which is described in the third embodiment, is satisfied. Therefore, when Vth(T4)+VDS(T2) <Vth(T3), the formula (7) or formula (8), which are described in the third embodiment, can be satisfied. Therefore, the sharp current change is prevented so that the noise increase can be prevented.

### Fifth Embodiment

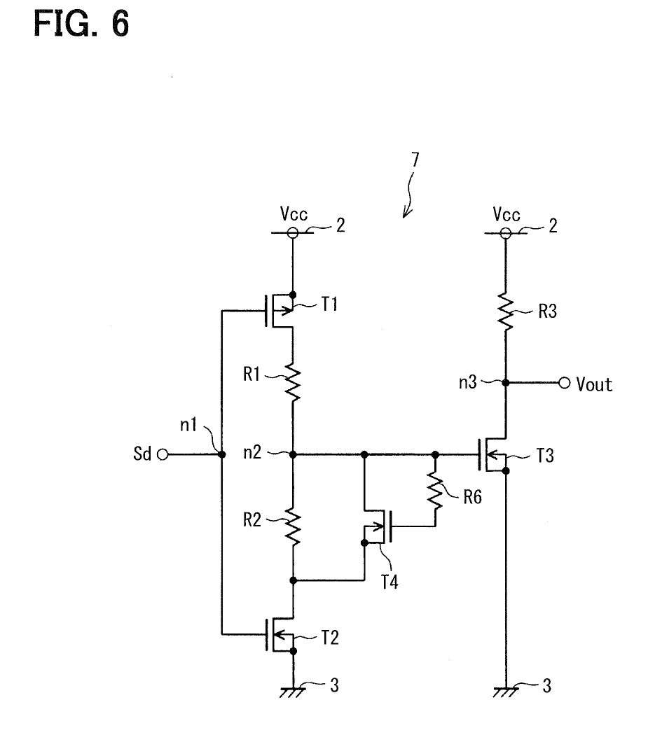

An output circuit 7 according to a fifth embodiment of the present invention is described below with reference to FIG. 6. The fifth embodiment differs from the fourth embodiment in the following points.

The output circuit 7 includes a resistor R6 instead of the diode D3. The resistor R6 is connected between the gate of the transistor T4 and the gate of the transistor T3. The resistor R6 serves as a regulatory element for generating a voltage corresponding to a current flowing therethrough. Thus, the fifth embodiment can have the same effects as the fourth embodiment.

### Sixth Embodiment

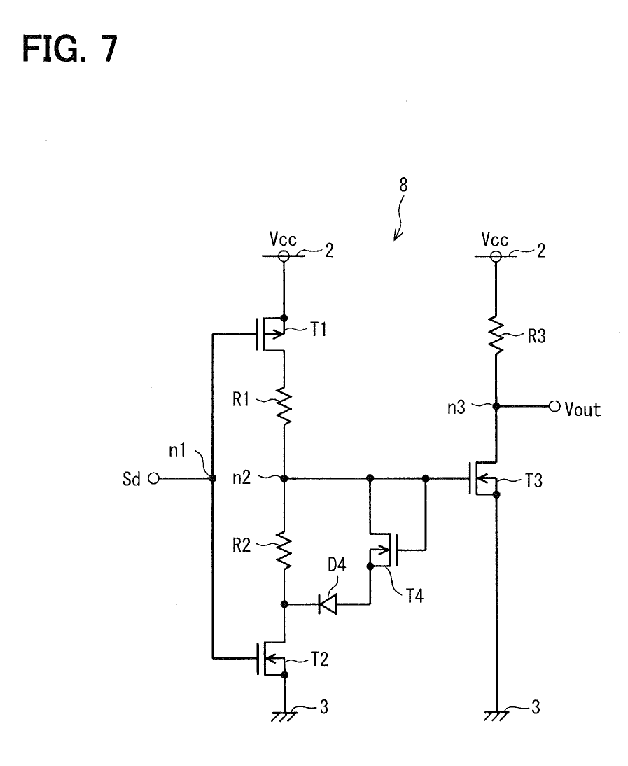

An output circuit 8 according to a sixth embodiment of the present invention is described below with reference to FIG. 7. The sixth embodiment differs from the fourth embodiment in the following points.

The output circuit 8 further includes a diode D4 instead of the diode D3. The diode D4 is connected to a path from the source of the transistor T4 to the resistor R2 (i.e., the drain of the transistor T2). The diode D4 serves as a regulatory element for generating a voltage corresponding to a current flowing therethrough. Thus, the sixth embodiment can have the same effects as the fourth embodiment.

### Seventh Embodiment

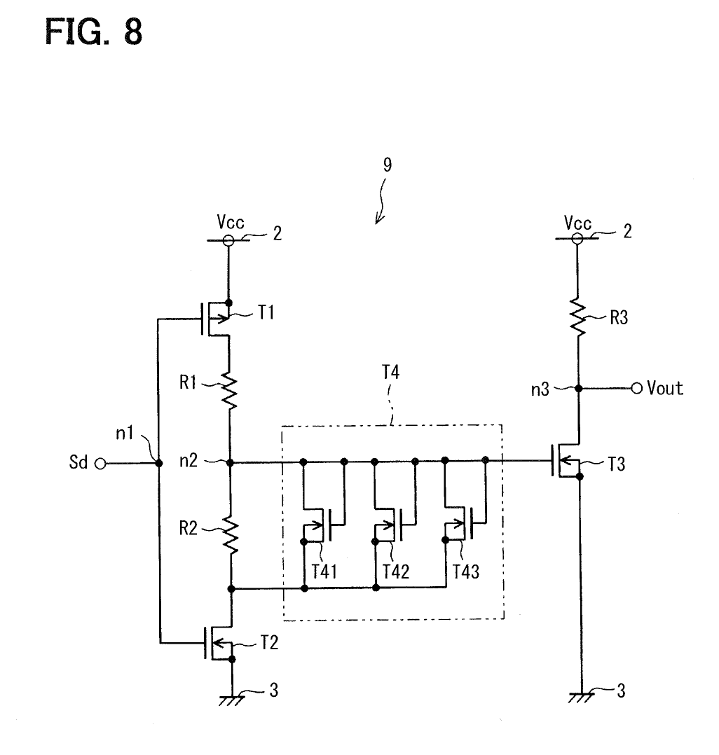

An output circuit 9 according to a seventh embodiment of the present invention is described below with reference to FIG. 8. The seventh embodiment differs from the first embodiment in the following points.

In the output circuit 9, the switching transistor T4 includes three transistors T41, T42, and T43 that are connected in parallel. Each of threshold voltages Vth(T41), Vth(T42), and Vth(T43) of the respective transistors T41, T42, and T43 is equal to or greater than the threshold voltage Vth(T3) of the output transistor T3. Further, the threshold voltages Vth(T41), Vth(T42), and Vth(T43) of the transistors T41, T42, and T43 are different from each other.

In a case where Vth(T43)>Vth(T42)>Vth(T41) Vth(T3), when the drive signal Sd changes to the high level, the transistor T2 is turned ON so that all the transistors T41, T42, and T43 can be turned ON. As a result, ON-resistances of the transistors T41, T42, and T43 are connected in parallel to the discharge path through which the charge in the gate capacitance of the transistor T3 is discharged. Thus, a resistance of the discharge path is minimized so that the charge in the gate capacitance of the transistor T3 can be discharged rapidly. Assuming that VDS(T2)≈0V, when the gate-source voltage VGS(T3) of the transistor T3 decreases below the threshold voltage Vth(T43) of the transistor T43, the transistor T43 is turned OFF so that the ON-resistances of the transistors T41 and T42 are connected in parallel to the discharge path. Then, when the gate-source voltage VGS(T3) of the transistor T3 decreases below the threshold voltage Vth(T42) of the transistor T42, the transistor T42 is turned OFF so that the ON-resistance of the transistor T41 can be connected in parallel to the discharge path. Finally, the transistor T41 is turned OFF so that all the transistors T41, T42, and T43 can be OFF. As a result, the charge in the gate capacitance of the transistor T3 is discharged gently through the resistor R2.

Thus, the seventh embodiment can have the same effects as the first embodiment. Further, according to the seventh embodiment, the rate of the change of the gate-source voltage VGS(T3) decreases stepwise before the gate-source voltage VGS(T3) reaches the threshold voltage Vth(T3). In such an approach, the noise at the time of de-energization can be more reduced while reducing an increase in the turn-off time as much as possible.

### Eighth Embodiment

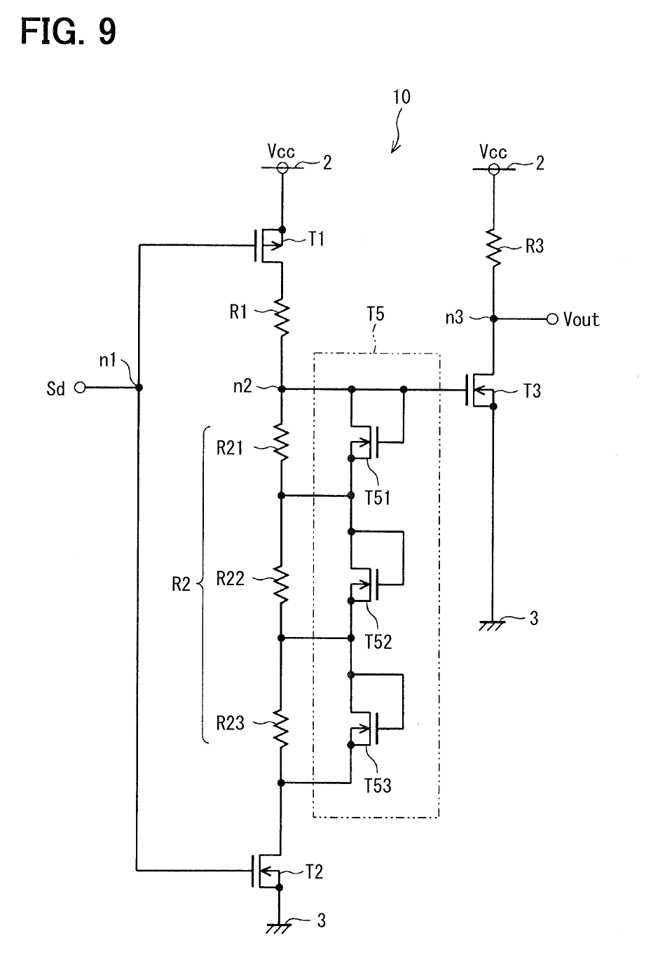

An output circuit 10 according to an eighth embodiment of the present invention is described below with reference to FIG. 9. The eighth embodiment differs from the first embodiment in the following points.

In the output circuit 10, the resistor R2 includes three resistors R21, R22, and R23 that are connected in series. The output circuit 10 includes a switching transistor T5 instead of the switching transistor T4. The transistor T5 has three transistors T51, T52, and T53 that are connected in series. The transistor T51 is connected in parallel to the resistor R21. The transistor T52 is connected in parallel to the resistor R22. The transistor T53 is connected in parallel to the resistor R23. A potential of the gate of the transistor T51 is closer to a potential of the gate of the transistor T3 than a potential of each of the transistors T52 and T53. The gate of the transistor T51 is connected to the gate of the transistor T3. The gate and drain of the transistor T52 are connected in a diode configuration. Likewise, the gate and drain of the transistor T53 are connected in a diode configuration.

In the output circuit 10, when the drive signal Sd changes to the high level, the transistor T2 is turned ON. At this time, if the following formula (9) is satisfied, all the transistors T51, T52, and T53 are turned ON.

Vth(T51)+Vth(T52)+Vth(T53)<Vcc−VDS(T1) (9)

As a result, the series circuit of the transistors T51, T52, and T53 serves as the discharge path so that the resistance of the discharge path can be minimized. Thus, the charge in the gate capacitance of the transistor T3 is discharged rapidly.

The action of the output circuit 10 observed when the gate-source voltage VGS(T3) of the transistor T3 further decreases depends on the resistances of the resistors R21, R22, and R23 and the threshold voltages Vth(T51), Vth(T52), and Vth(T53) of the transistors T51, T52, and T53. For example, when the threshold voltages Vth(T51), Vth(T52), and Vth(T53) are equal, the transistors T51, T52, and T53 are turned OFF in the order of resistance from smallest to largest of the resistors R21, R22, and R23. For another example, when the threshold voltages Vth(T51), Vth(T52), and Vth(T53) are different from each other, the actions of the transistors T51, T52, and T53 depend on the resistances of the resistors R21, R22, and R23.

Thus, the eighth embodiment can have the same effects as the first embodiment. Further, according to the eighth embodiment, the rate of the change of the gate-source voltage VGS(T3) decreases stepwise. In such an approach, the noise at the time of de-energization can be more reduced while reducing an increase in the turn-off time as much as possible.

### Ninth Embodiment

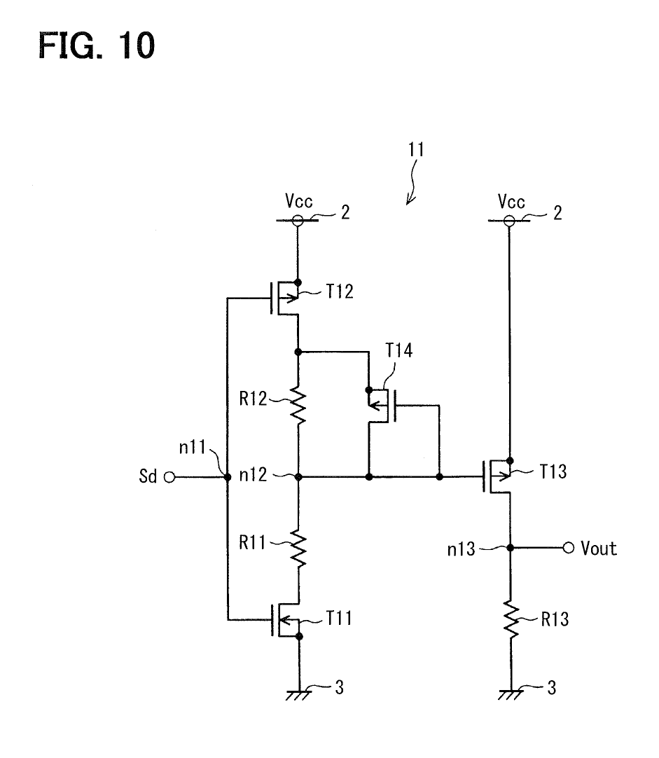

An output circuit 11 according to a ninth embodiment of the present invention is described below with reference to FIG. 10. The ninth embodiment differs from the first embodiment in the following points.

The output circuit 1 according to the first embodiment has a low side drive configuration. In contrast, the output circuit 11 according to the ninth embodiment has a high side drive configuration.

Specifically, in the output circuit 11, a P-channel driving transistor T12, a resistor R12, a resistor R11, and an N-channel driving transistor T11 are connected in series between the first power line 2 and the second power line 3. Further, a P-channel output transistor T13 and a resistor R13 are connected in series between the first power line 2 and the second power line 3. The gates of the transistors T11, T12 are connected together to from an input node n11 for receiving the driving signal Sd. A node between the resistor R13 and the output transistor T13 forms an output node n13 for outputting the output voltage Vout. A node n12 between the resistors R11, R12 is connected to the gate of the transistor T13. A P-channel switching transistor T14, which has the same conductivity type as the transistor T13, is connected in parallel with the resistor R12. The gate of the transistor T14 is connected to the gate of the transistor T13.

In the output circuit 11, when the drive signal Sd is at the high level, the transistor T11 is ON, and the transistor T12 is OFF. Therefore, the gate-source voltage VGS(T13) is almost equal to the power supply voltage Vcc so that the transistor T13 can be ON. At this time, the output voltage Vout is almost equal to the power supply voltage Vcc, and a load current flows through the transistor T13.

Then, when the drive signal Sd changes to the low level, the transistor T11 is turned OFF, and the transistor T12 is turned ON. At this time, the transistor T14 is turned ON so that the charge in the gate capacitance of the transistor T13 is discharged rapidly through the transistors T12, T14 by bypassing the resistor R12. As a result, the gate-source voltage VGS(T13) of the transistor T13 sharply decreases. Then, when the gate-source voltage VGS(T13) decreases below Vth(T14)+VDS(T12), the transistor T14 is turned OFF. After the transistor T14 is turned OFF, the charge in the gate capacitance of the transistor T13 is discharged gently through the resistor R12 and the transistor T12. In this way, the ninth embodiment can have the same effects as the first embodiment.

### Tenth Embodiment

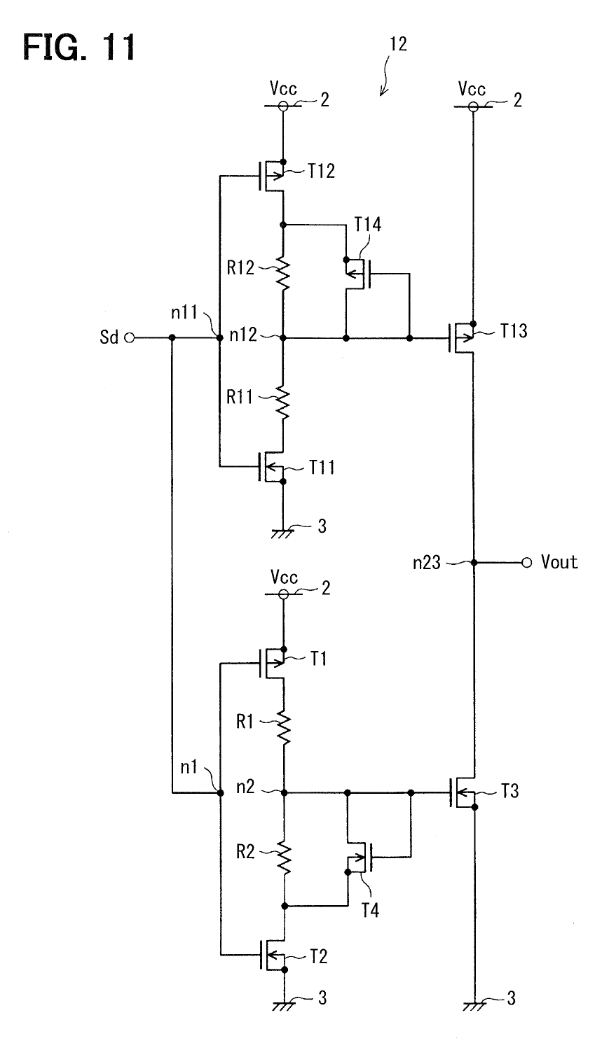

An output circuit 12 according to a tenth embodiment of the present invention is described below with reference to FIG. 11. The output circuit 12 corresponds to a combination of the output circuit 1 of the first embodiment and the output circuit 11 of the ninth embodiment. The drive signal Sd is supplied to the gates of the transistors T1 and T2 and the gates of the transistors T11 and T12. The transistors T13 and T3 are connected in series between the first power line 2 and the second power line 3. A node between the transistors T13 and T3 forms an output node n23 for outputting the output voltage Vout.

In the output circuit 12, when the drive signal Sd is at the low level, the transistor T3 is ON, and the transistor T13 is OFF, so that the output voltage Vout can become almost 0V. Then, when the drive signal Sd is at the high level, the transistor T3 is OFF, and the transistor T13 is ON, so that the output voltage Vout can become almost the power supply voltage Vcc. Thus, according to the tenth embodiment, the noise increase can be reduced even when the output voltage Vout changes in both directions depending on the change in the driving signal Sd. Further, the turn-off time is reduced so that a time period where a shoot-through current flows can be reduced.

(Modifications)

The above embodiments described above can be modified in various ways, for example, as follows.

The driving transistor, the output transistor, and the switching transistor are not limited to a MOS transistor (MOSFET). For example, the driving transistor, the output transistor, and the switching transistor can be a bipolar transistor, an IGBT, or the like, as long as the output transistor and the switching transistor have the same junction type (i.e., PNP/NPN) or the same conductivity type (i.e., P-channel/N-channel).

When the current limiting element and the regulatory element are resistors, an ON-resistance of the MOSFET can be used.

A voltage between the first and second power lines 2, 3 between which the driving transistors T1 and T2 (or T12, T11) are connected in series can be different from a voltage between the first and second power lines 2, 3 between which the resistor R3 (or R13) and the output transistor T3 (or T13) is connected in series.

The second to sixth embodiments can be combined in any way. The seventh embodiment can be combined with any of the second to sixth embodiments, the ninth embodiment, and the tenth embodiment. When the seventh embodiment is combined with the fourth embodiment, the diode D3 is connected between the gate of the transistor T3 and each of the gates of the transistors T41, T42, and T43. When the seventh embodiment is combined with the fifth embodiment, the resistor R6 is connected between the gate of the transistor T3 and each of the gates of the transistors T41, T42, and T43. When the seventh embodiment is combined with the sixth embodiment, the diode D4 is connected to each of the sources of the transistors T41, T42, and T43. Alternatively, when the seventh embodiment is combined with the sixth embodiment, a common diode D4 can be connected to a path from the source of the transistor T4 to the resistor R2 (i.e., drain of the transistor T2).

The eighth embodiment can be combined with any of the second to sixth embodiments, the ninth embodiment, and the tenth embodiment. When the eighth embodiment is combined with the fourth embodiment, the diode D3 is connected between the gate of the transistor T3 and the gate of the transistor T51 and between the gate and drain of at least one of the transistors T52 and T53. When the eighth embodiment is combined with the fifth embodiment, the resistor R6 is connected between the gate of the transistor T3 and the gate of the transistor T51 and between the gate and drain of at least one of the transistors T52 and T53. When the eighth embodiment is combined with the sixth embodiment, the diode D4 is connected at least one of between the source of the transistor T51 and the drain of the transistor T52, between the source of the transistor T52 and the drain of the transistor T53, and in a path from the source of the transistor T53 to the resistor R23 (i.e., drain of the transistor T2).

Likewise, the ninth embodiment can be combined with any of the second to eighth embodiments.

Such changes and modifications are to be understood as being within the scope of the present invention as defined by the appended claims.

What is claimed is:

1. An output circuit comprising:
a driving transistor having a first terminal, a second terminal, and a control terminal, the first terminal of the driving transistor connected to a power line;
an output transistor having a first terminal and a control terminal, the first terminal of the output transistor connected to the power line;
a current limiting element connected between the second terminal of the driving transistor and the control terminal of the output transistor; and
a switching transistor having a control terminal and connected in parallel to the current limiting element, wherein
the output transistor and the switching transistor have the same junction type or the same conductivity type, and
the control terminal of the switching transistor is connected to the control terminal of the output transistor.

2. The output circuit according to claim 1, further comprising:
a regulatory element connected between the driving transistor and the parallel circuit of the current limiting element and the switching transistor, wherein
the regulator element generates a voltage corresponding to a current flowing therethrough.

3. The output circuit according to claim 2, wherein
the sum of a threshold voltage of the switching transistor and the voltage generated by the regulator element during ON-state of the switching transistor is equal to or greater than a threshold voltage of the output transistor.

4. The output circuit according to claim 1, further comprising:
a regulatory element connected in a first path from the control terminal of the switching transistor to the control terminal of the output transistor or a second path from a source or an emitter of the switching transistor to the current limiting element, wherein
the regulator element generates a voltage corresponding to a current flowing therethrough.

5. The output circuit according to claim 4, wherein
the sum of a threshold voltage of the switching transistor and the voltage generated by the regulator element is equal to or greater than a threshold voltage of the output transistor.

6. The output circuit according to claim 2, wherein
the regulator element is a resistor or a diode.

7. The output circuit according to claim 1, wherein
the switching transistor comprises a plurality of switching transistors that are connected in parallel, and
threshold voltages of the plurality of transistors are different from each other and equal to or greater than a threshold voltage of the output transistor.

8. The output circuit according to claim 1, wherein
the current limiting element comprises a plurality of current limiting elements that are connected in series,
the switching transistor includes a plurality of switching transistors that are connected in series,
each switching transistor is connected in parallel with a corresponding current limiting element,
a control terminal of one switching transistor is connected to the control terminal of the output transistor,
a control terminal of each of the other switching transistors is connected in a diode configuration, and
a potential of the control terminal of the one switching transistor is closer to a potential of the control terminal of the output transistor than a potential of the control terminal of each of the other switching transistors.
